(19) United States
(12) Patent Application Publication
(10) Pub. No.: US 2007/0299833 A1
(43) Pub. Date: Dec. 27, 2007

(54) Network-based determination of user content preferences

(76) Inventors: Timo-Pekka Viljamaa, Helsinki (FI); Akseli Anttila, Helsinki (FI)

Correspondence Address: Hollingsworth & Funk, LLC;Suite 125, 8009 34th Avenue South, Minneapolis, MN, 55425, US

(21) Appl. No.: 11/472,505

(22) Filed: Jun. 21, 2006

(51) Int. Cl. G06F 17/30

(52) U.S. Cl. 707/4

(57) ABSTRACT

Network-based determination of user content preferences involves determining preferences of a plurality of users via respective network-capable processing devices of the users. The preferences are collected via a network entity and merged to form a group preference associated with the plurality of users. Content is provided to at least one of the users using the group preferences

### FIELD OF THE INVENTION

This invention relates in general to data processing, and more particularly to tailoring content to conform to group preferences.

### BACKGROUND OF THE INVENTION

Networking technology, particularly the Internet, has enabled many new types of human intercommunications. Applications such as email and instant messaging allow real-time and near-real time-communications in electronic formats that are easily readable, storable, and searchable. Applications such as Web browsing allow publication of rich content that can be created and shared with unprecedented speed and scope. The digitization of media, including sound and video, enables convenient access to the media via the Web, and allows people to explore new content without having to travel to a retailer and search through store shelves.

Using technologies such as Internet search, a savvy user can discover digital media and other digitized works that could be difficult to find in traditional outlets, such as in stores or via broadcasts. For example, musicians can gain wide exposure at minimal costs by offering sample works online. These sample works can be obtained via streaming and/or downloading. Some content aggregation services and search engines can help lead interested users to find and listen to such samples. If a particular work generates significant interest on the Internet, this can increase the musician's name recognition and may lead to financial rewards such as CD and ticket sales. The listeners who discover such works via network tools are also rewarded by the discovery of new and interesting works.

Even though search engines can be powerful and sophisticated tools, even experienced users can have difficulty using these tools effectively. Where the searched database is very large, the chances of getting extraneous results increases. Also, the limitations and vagaries of language often makes forming an effective search query seem like more of an art than a science. This is particularly true when it comes to searching for network content such as media for personal enjoyment (e.g., music, literature, movies, art, etc.) that is selected based on a user's personal tastes. Personal tastes can be hard to describe in the form of a search query, and the end user may have to adopt a trial and error approach when trying to discover such media. For some users, the exploration is part of the enjoyment, but others would prefer to get accurate results with the least amount of effort. The present disclosure describes ways in which content discovery can be improved to provide faster and more accurate results than existing techniques.

### SUMMARY OF THE INVENTION

To overcome limitations in the prior art described above, and to overcome other limitations that will become apparent upon reading and understanding the present specification, the present invention discloses a system, apparatus and method for network-based determination of user content preferences. In one embodiment, a method involves determining preferences of a plurality of users via respective processing devices of the users, where the devices are capable of being coupled to a network. The preferences are collected via a network entity, and the preferences are merged to form a group preference associated with the plurality of users. Content is provided to at least one of the users using the group preferences.

In more particular embodiments, providing the content to the at least one users using the group preferences involves tailoring of a content search initiated by the at least one of the users in conformance with the group preferences. Tailoring of the content search in conformance with the group preferences may involve modifying a search query sent out by the at least one of the users and/or modifying a response to a search query sent out by the at least one of the users. In one arrangement, providing the content to the at least one user using the group preferences involves pushing the content to the processing devices of the user via the network.

In other, more particular embodiments, determining the preferences of the plurality of users involves deriving preferences based on interactions between the plurality of users and applications of the respective processing devices and/or accepting explicit indicators of the preferences from the users via user interfaces of the data processing devices. In one configuration, the method further involves combining an individual preference of the at least one of the users with the group preference to form a resultant preference that reflects the individual preference and the group preference, and providing content to the at least one of the users using the resultant preference. In such an arrangement, combining the individual preference of the at least one user with the group preference to form the resultant preference involves applying predetermined respective weightings to the individual preferences and the group preferences.

In other, more particular embodiments, merging the preferences to form the group preference further involves merging the preferences with a separate source of preferences that is independent of the preferences of the plurality of users. The separate source of preference may include an Internet content provider service. In one configuration, the preferences of the plurality of users are formatted using two or more incompatible formats, and merging the preferences to form the group preference further involves translating the preferences to a common format.

In another embodiment, an apparatus, includes a network interface capable of communicating via a network and a user interface capable of receiving user inputs. A processor is coupled to the network interface and the user interface, and a memory is coupled to the processor. The memory includes instructions that cause the processor to: a) determine, via the user inputs, preferences of the user of the apparatus that may be used to discover content for rendering via the apparatus; b) communicate the user preferences to an entity of the network for purposes of combining the user preferences with preferences of others on the network to form group preferences; c) discover, via the entity, content in accordance with the group preferences; and d) retrieve the content via the network for purposes of rendering the content to the user.

In more particular embodiments, the memory further includes one or more applications that accept inputs via the user interface, and the instructions cause the processor to determine the preferences of the user based on interactions between the user and the one or more applications. The user inputs may include explicit indicators of the preferences input from by the user via the user interface.

In another embodiment, a computer-readable medium has instructions that are executable by a processing device capable of being coupled to a network. The instructions are executable for performing steps including determining, via a user interface of the processing device, preferences of the user of the processing device that may be used to discover content for rendering via the processing device and communicating the user preferences to an entity of the network for purposes of combining the user preferences with preferences of others on the network to form group preferences. The steps also include discovering, via the entity, content in accordance with the group preferences, and retrieving the content via the network for purposes of rendering the content to the user.

In another embodiment, an apparatus includes a network interface capable of communicating with a plurality of user devices via a network. A processor is coupled to the network interface and a memory is coupled to the processor. The memory includes instructions that cause the processor to, collect, via the plurality of user devices, preferences of the respective users of the plurality of user devices. The preferences are determined via the plurality of user devices. The instructions also cause the processor to merge the preferences to form a group preference associated with the users of the plurality of user devices, and facilitate providing content to users using the group preferences.

In more particular embodiments, the instructions cause the processor to provide the content to the at least one users using the group preferences by tailoring of a content search initiated by at least one of the users in conformance with the group preferences. The instructions may cause the processor to tailor the content search in conformance with the group preferences by modifying a search query sent out by the users and/or by modifying a response to a search query sent out by the users. In other arrangements, the instructions further cause the processor to combine an individual preference of at least one of the users with the group preference to form a resultant preference that reflects the individual preference and the group preference and provide content to the at least one of the users using the resultant preference.

In other, more particular embodiments, the instructions cause the processor to merge the preferences to form the group preference further by merging the preferences with a separate source of preferences that is independent of the preferences of the plurality of users. The separate source of preference may include an Internet content provider service. In one configuration, the preferences of the plurality of users are formatted using two or more incompatible formats, and wherein the instructions cause the processor to merge the preferences to form the group preference by translating the preferences to a common format.

In another embodiment, a computer-readable medium has instructions that are executable by a server device capable of being coupled to a network. The instructions are executable for performing steps including collecting, via a plurality of user devices coupled to the network, preferences of the respective users of the plurality of user devices. The preferences are determined via the plurality of user devices. The steps also include merging the preferences to form a group preference associated with the users of the plurality of user devices, and facilitating providing content to users using the group preferences.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram illustrating a system according to embodiments of the invention;

FIGS. 2A-F are block diagrams illustrating uses of a community preference server according to embodiments of the invention;

FIGS. 3A-D are block diagrams illustrating uses of a generic preference server according to embodiments of the invention;

FIG. 4 is a block diagram of a mobile device according to embodiments of the invention;

FIG. 5 is a block diagram of a network server apparatus according to embodiments of the invention; and

FIG. 6 is a flowchart illustrating a method for providing content to users of processing devices according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention relates to methods, systems, and apparatus that enable people to discover digital content that is more accurately aligned with their personal preferences. The preferences of each individual may be tracked automatically by user actions and behaviors and stored in a common database. The individual preferences stored in the database can be combined into a set of group preferences to refine tasks such as content searching and discovery. In other arrangements, the users may upload data to network servers that conform to their tastes. The personal preferences may be determined using this uploaded data.

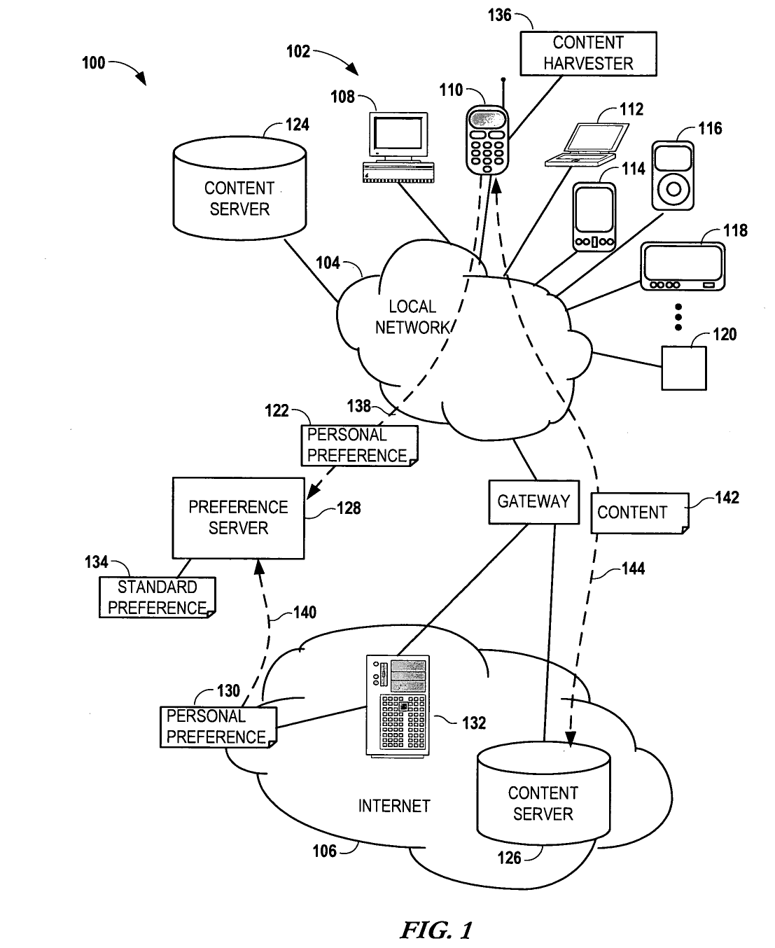

In reference now to FIG. 1, a system 100 according to an embodiment of the invention is illustrated. Generally, a plurality of user devices 102 are coupled via one or more networks, such as a local network 104, or a wide area network such as the Internet 106. The devices 102 may include any type of data processing equipment, including personal computers 108, cellular phones 110, portable computers 112, personal digital assistants (PDA) 114, digital music players 116, tablet computers 118, or any other device represented by generic device 120.

In the illustrated system, a user device (e.g., device 110) creates a personal preference file 122 through the actions and usage behaviors of the user. As used herein, actions generally refer to an explicit action by the user to mark a content item as interesting or uninteresting (e.g., when rating content). In contrast, behavior generally involves observation of the user's content usage by the devices 102 or other apparatus. These behaviors may involve any combination of selecting/rejecting items, tracking the number of times an item has been used, and actions taken during the usage of an item, such as skipping items in a content stream, uploading content to another user or to a network service, etc.

The preference file 122 may be stored within the system 100 to enhance the user experience when utilizing system content. For example, the preference file 122 may be used to filter large numbers of content matches when searching local or remote content via the networks 104, 106. This makes the search results smaller and more manageable, as well as more likely to conform to the user's tastes. For example, if a user searches for “rock music” the number of matches may be weighed towards “metal rock music” according to the user's preference file 122.

Preference files 122 may be used in conjunction with content servers 124, 126 to provide suitable content to an individual user or a community of users. The content servers 124, 126 generally store and distribute digital content in the form of downloadable files or media streams to the user devices 102, or to any other device where the media may benefit the user. In the illustrated arrangement, where the environment 100 includes multiple devices 102 and services 124, 126, a preference server 128 can gather dissimilar preferences from various locations and formats. For example, the preference server 128 can access preference file(s) 122 associated with the user device 110. The preference server 128 may also access preferences from a source that is independent of the preference files 122, such as a preference file 130 associated with an Internet service 132, such as an online music service. The preference server 128 can convert the preferences 122, 130 to a standard preference file 134. For example, a plug-in content harvester 136 that resides on the user device 110 (or elsewhere, such as preference server 128 or Internet server 132) can collect disparate preference data 122, 130, as represented by paths 138, 140. The content harvester 136 can either convert the preferences 122, 130 to the common format before sending 138, 140, or the receiving element 128 can do the conversion and merging into the single presence file 134.

Besides managing preferences 122, 130, the content harvester 136 may also be able to use local preferences 122 and/or group preferences 134 to drive content 142 to and from the user device 110. For example, as indicated by path 144, the preferences 122, 130 can be used to send content 142 from the content server 126 to the device 110 for consumption by the device user. Alternatively, the preferences 122, 130 may be used to send the content 142 to the content server 126 or other network entity. The latter case may be used for synchronizing or backing up user data from the device 110. This uploading of content 142 from the device 110 may also act as a form of local data mining, e.g., extracting important data from a large amount of data that is found on the user device 110. Generally, this important data can be determined by way of the personal and/or group preferences 122, 130.

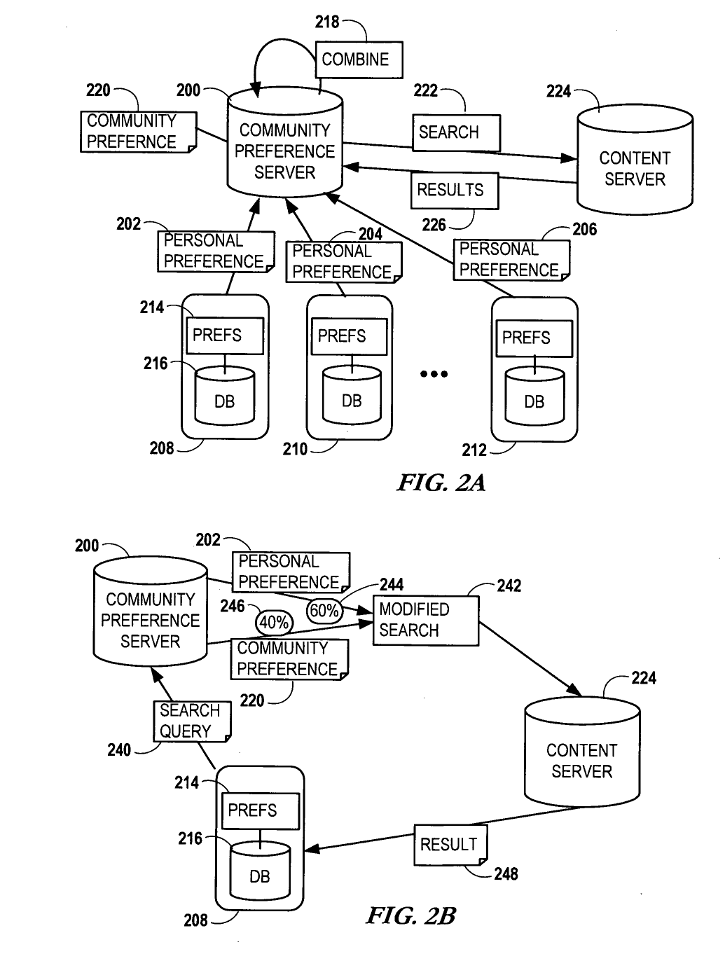

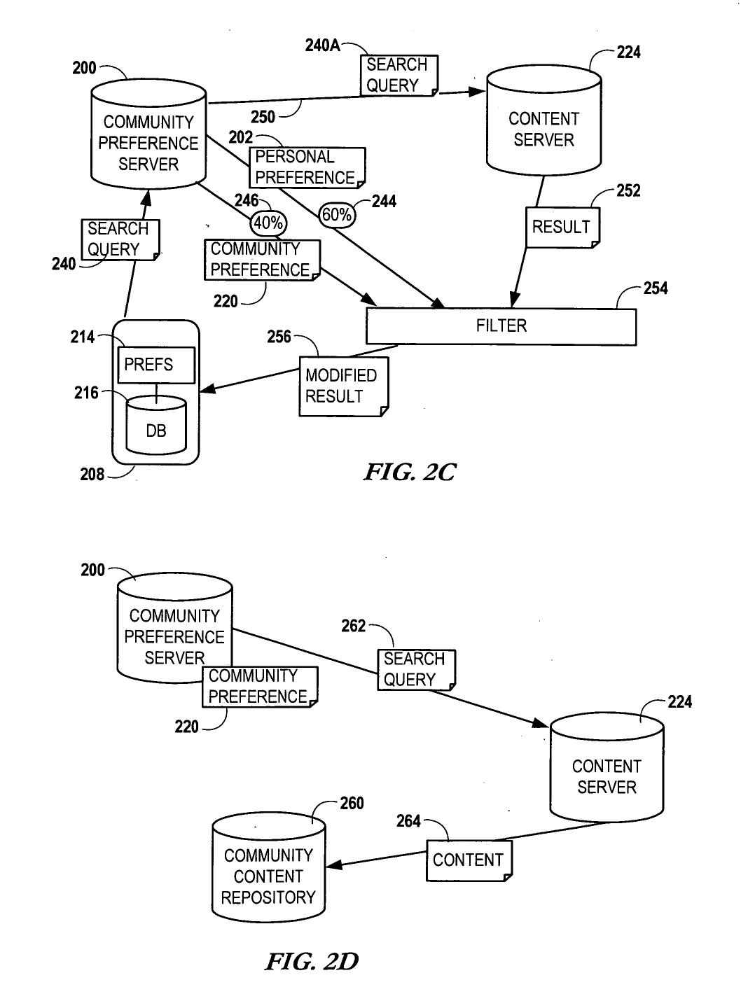

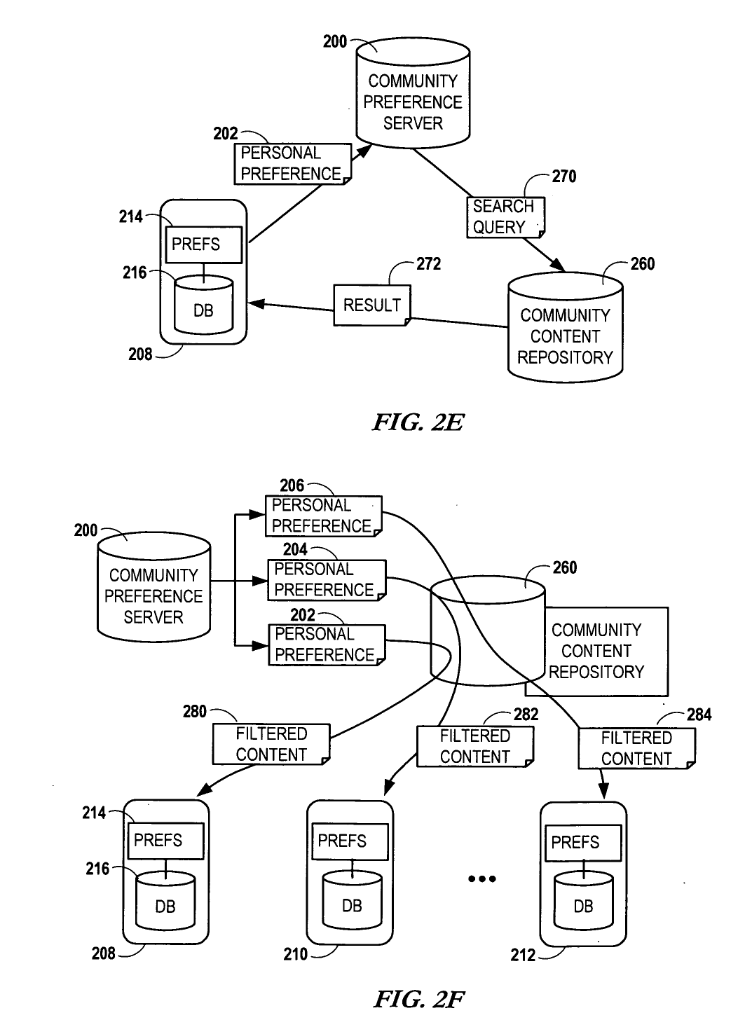

Personal preference files can be created automatically through user action or user behaviors and sent to a community preference server or a generic preference server using standard XML or similar Web-service-compliant presentation. A scenario of maintaining user profiles at a community preference server 200 according to embodiments of the invention is shown in FIG. 2A. A community preference server 200 collects preferences 202, 204, 206 from multiple community members, as represented by terminal devices 208, 210, and 212. The terminal devices 208, 210, 212 each contain internal components that enable communication with the community preference server 200, as exemplified by preferences interface 214 and preference database 216 on device 208.

The community preference server 200 stores the received preference data 202, 204, 206. The stored preference data 202, 204, 206 can be combined 218 by the community preference server 200 to create a community preference file 220. The community preference file 220 can be used when searching for content available to all member devices 208, 210, and 212. For example, a search request 222 that is sent to a content server 224 on behalf of one or more of the devices 208, 210, and 212 may include special modifiers to ensure results 226 are returned that is in conformance with the community preferences. Alternatively, the search 222 could be sent out unaltered, and the results 226 filtered or otherwise modified by the preference server 200 to conform to the community preferences 220. Those skilled in the art will appreciate that the term “search,” as used herein, may refer to any combination of actions that enable the discovery of data, including directory browsing, enumerating, pattern matching, random selection, traversal of data structures/hierarchies, database queries, etc.

The results 226 that are processed by via the community preference server 200 are generally tailored to reflect some combination of the tastes of the individual (e.g., via preferences 208, 210, and 212) and the community (e.g., via community preference 220). Combining group and individual preferences according to embodiments of the invention is shown in the block diagram of FIG. 2B, wherein the same reference numbers are used to denote components corresponding to those in FIG. 2A. In this example, the user of device 208 has sent out a search query 240. The query 240 may be a standard search engine query submitted via a browser, or may be a specialized query that uses the preferences interface 214 or other specialized software. The search query 240 is intercepted by the community preference server 200 and used to form a modified query 242 using some combination of the user's own preference data 202 and the community preference data 220.

In the illustrated example, the modified query 242 is formed by applying respective weightings 244, 246 to the personal preference data 202 and the community preference data 220. Here, the personal preference data 202 is given a greater weighting 244 than the community data weighting 246 (e.g., 60% versus 40%). These weighting values 244, 246 can be predetermined by the user, such as by applying the weightings 244, 246 on a default, per-user, and/or per-search basis. In response to the modified search 242, the content server 224 returns a result 248 to the user device 208. The result 248 may be returned directly to the device 208 from the content server 224, or via the community preference server 200.

A different scenario of combining group and individual preferences according to embodiments of the invention is shown in the block diagram of FIG. 2C, wherein the same reference numbers are used to denote components corresponding to those in FIG. 2A-B. Here, the original search query 240 is passed to the content server 224 unaltered, as indicated by query 240A on path 250. However, the result 252 from this query 240A is passed to a filter 254, which may either be part of the community preference server 200 or some other intermediate entity. Although the filter 254 may remove some entries from the original result 252, it may also sort, order, and otherwise modify the result 252 in accordance with the personal preference data 202 and the community preference data 220. Here, the weightings 244, 246 of the personal preference data 202 and the community preference data 220 are used by the filter to form the modified result 256, which is then passed to the user device 208.

In the examples of FIGS. 2B-C, the results provided to the user device 208 are in response to queries initiated via the user device 208. However, the community server system can also independently download content into a communally accessible repository based on personal and community preferences. An example of downloading of community content into a community content repository 260 according to embodiments of the invention is shown in FIG. 2D, wherein herein the same reference numbers are used to denote components corresponding to those in FIG. 2A. In this example, the community preference server 200 initiates its own search query 262 based on at least community preferences 220. The search query 262 is directed to the content server 224, which returns results in the form of content 264. This content is stored on the community content repository 260, which is then made accessible to individual members of the community.

The content server 224 can periodically perform queries 262 or use other mechanisms to update the contents of the community repository 260. In reference now to FIG. 2E, a block diagram illustrates access by users to the community content repository 260 according to embodiments of the invention, wherein the same reference numbers are used to denote components corresponding to those in FIGS. 2A and 2D. A device 208 of a community member can search the community content repository 260 via the community preference server 200 using the member's personal preference file 202 as a filter. As in previous examples, the personal preference file 202 may be used to modify any combination of a search query 270 submitted to the repository 260 and a result 272 return in response to the query 270. The initial request that causes the query 270 to be issued can be initiated via either a standard browser, or customized software such as the preferences interface 214.

Just as the community preference server 200 can push content from an external content repository, the preference server 200 can also push content to user devices. An example of content push to user devices according to embodiments of the invention is shown in FIG. 2F, wherein the same reference numbers are used to denote components corresponding to those in FIGS. 2A and 2D. User devices 208, 210, and 212 have registered their respective preferences 202, 204, 206 with the community preference server 200, such as was described in relation to FIG. 2A. The preference server 200 pushes different content 280, 282, 284 from the community content repository 260 to the devices 208, 210, 212 depending on the respective personal preferences 202, 204, 206. Because the content contained in the community content repository 260 is already collected based on aggregated community preferences (e.g., such as described in relation to FIG. 2E), the resulting content 280, 282, 284 is selected based on both group preferences (e.g., community preferences 220 in FIG. 2D) and individual preferences 202, 204, 206. Although the content 280, 282, 284 is shown being pushed from the content repository 260 to the devices 208, 210, 212, it will be appreciated that other methods may be used to push content, including peer-to-peer content push between devices 208, 210, 212 that is enabled/assisted via the preference server 200 or other entity that handles preferences 202, 204, 206, including the devices 208, 210, 212 themselves.

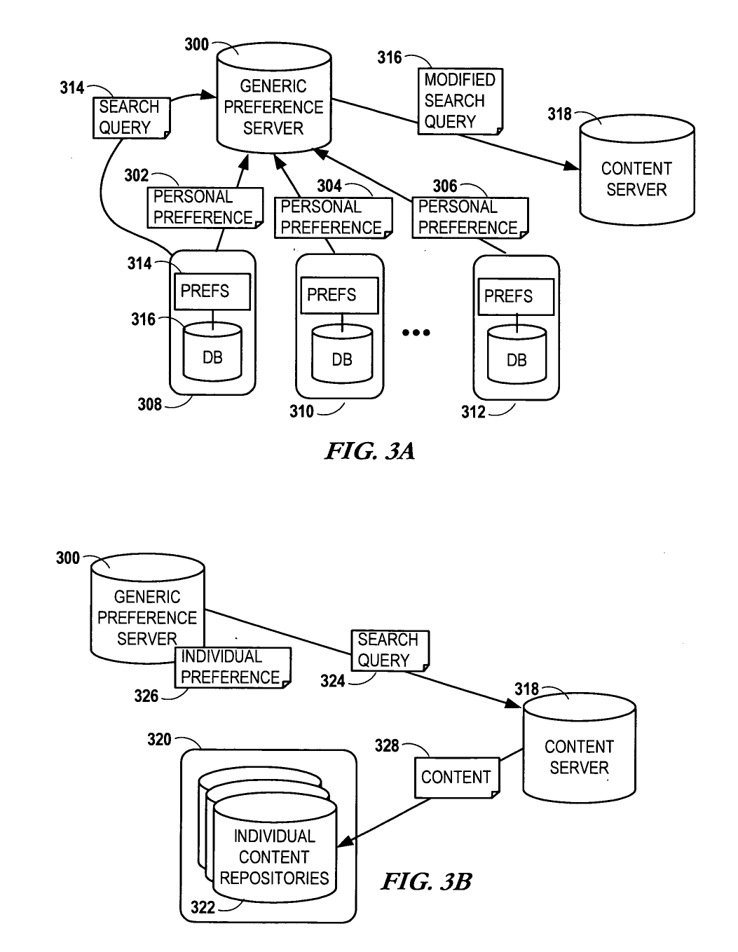

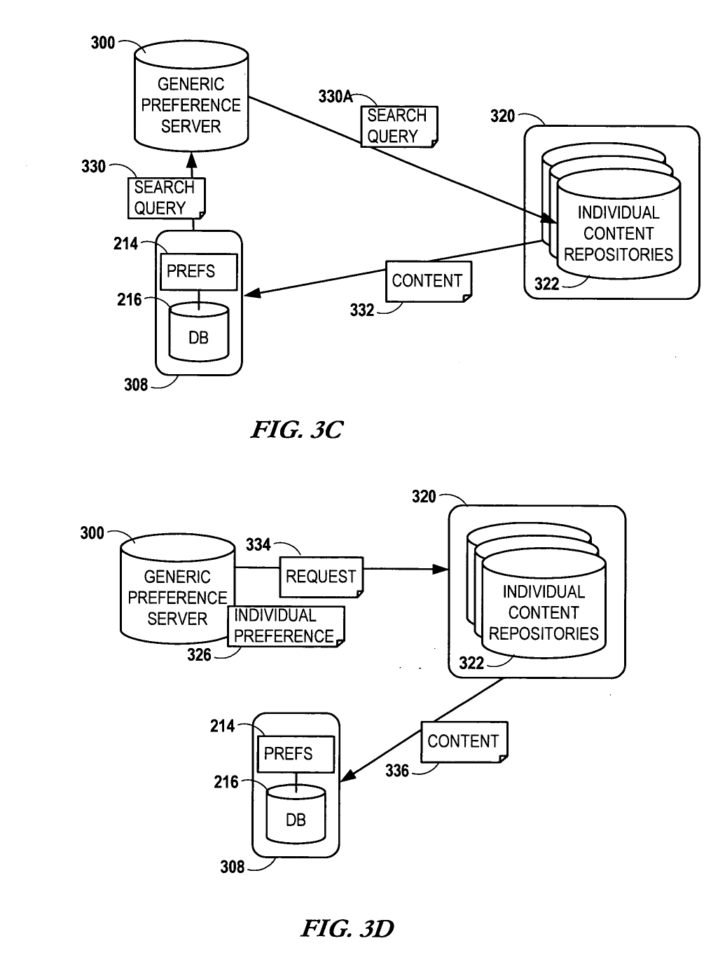

In other embodiment of the present, the individual preferences may be stored in a generic preferences server and applied separately. An example preference system according to embodiments of the invention is shown in the block diagram of FIG. 3A. A generic preference server 300 collects preferences 302, 304, 306 from devices 308, 310, and 312, respectively, that are owned by different individuals. The devices 308, 310, 312 each contain internal components that enable communication with the generic preference server 300, as exemplified by preferences interface 314 and preference database 316 on device 308. Although the devices 308 are capable of storing and using the preferences database 316, in the illustrated example, the preferences 302, 304, 306 are stored on the preference server 300, and used from there to affect the receipt of content by the devices 308, 310, 312. For example, device 308 directs a search query 314 via the preference server 300, which modifies the query 314 based on the stored preference 302 to form the modified search query 316. A content server 318 returns content (not shown) based on the modified query 316. It will be appreciated that the generic preference server 300 may also modify (e.g., filter) the results returned from search queries directed to the content server 318 using the applicable stored preference data 302, 304, 306.

The generic preference server 300 may collect preferences 302, 304, 306 from multiple users and store them as individual preference files, which are used when searching for content for that particular user. The generic preference server system 300 can also independently download content using the individual preference file into an individual content repository. The use of an individual content repository according to embodiments of the invention is shown in FIG. 3B, wherein the same reference numbers are used to denote components corresponding to those in FIG. 3A. A content repository 320 includes a number of individual content repositories, such as individual repository 322, which stores data for a particular user. The generic preference server 300 forms a search query 324 based on an individual preference 326 of the end user. This search query 324 is used to obtain content 328, that is then pushed to the individual repository 322. The end user can thereafter access this content 328, as is shown in FIGS. 3C and 3D, wherein the same reference numbers are used to denote components corresponding to those in FIGS. 3A and 3B.

FIG. 3C shows a user-requested download of content from an individual repository 322 according to embodiments of the invention. The individual content repository 322 is filled with content based on a user preference, such as described in relation to FIG. 3B. The user device 308 sends a search query 330 that is received at the generic preference server 300. The generic preference server 300 directs the query 330A (which may be substantially unchanged from the original query 330) to the individual content repository 322 associated with the user of device 308. In response, the device 308 receives content 332 based on the query 330A. Because the individual repository 322 contains content that is in conformance with the user's individual preferences, the content 332 resulting from the search will already be tailored to the user's particular tastes.

FIG. 3D shows a push of data from the content repository 320 to the user in accordance with embodiments of the invention. The generic content server 300 sends a push request 334 to the entire content repository 320. The push request 334 is formed based on the user's individual preference file 302 that was previously communicated to the generic server 300, such as shown in FIG. 3A. The push request 334 may take the form of a specific content request, a search query, or other form of content retrieval request as is known in the art. Here, the entire repository 320 may respond to the request 334. The request 334 may be fulfilled based on the individual's own repository 322, or any other individual repository. The resulting content 336 is pushed to the end user device.

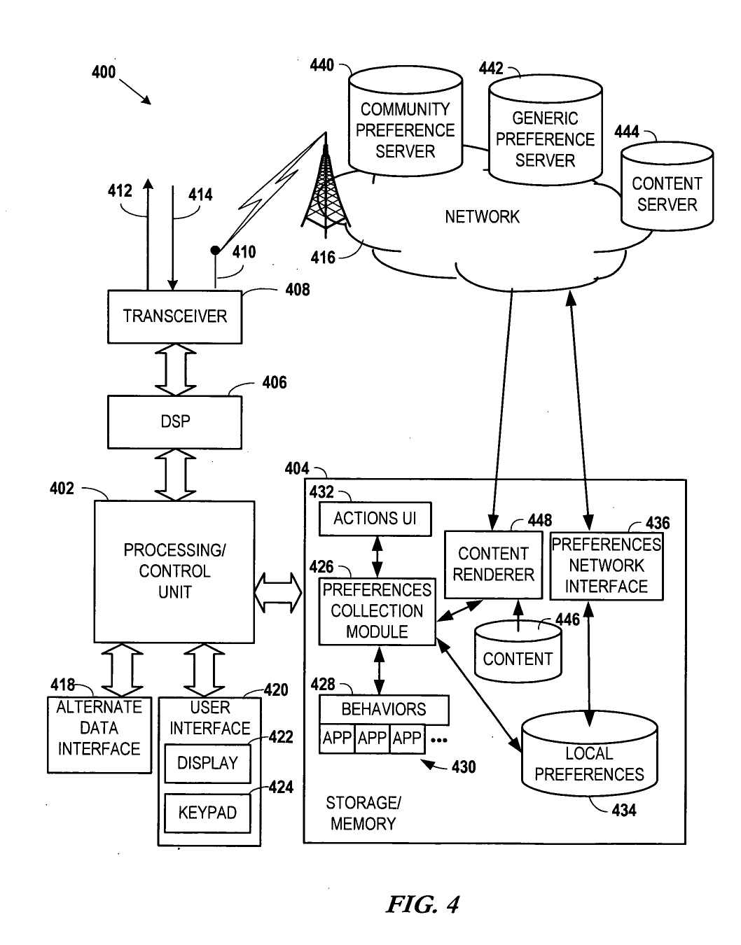

The end-user device can be used to determine individual user preferences, form search queries, and receive tailored content. These functions may be implemented in any data process device known in the art. Mobile devices may be particularly useful in this capacity, as mobile devices are gaining increased capacity and are often carried with the user. A user device that includes capabilities according to embodiments of the invention is shown as a mobile computing arrangement 400 in FIG. 4. Those skilled in the art will appreciate that the exemplary mobile computing arrangement 400 is merely representative of general functions that may be associated with such mobile devices, and also that landline computing systems similarly include computing circuitry to perform such operations.

The processing unit 402 controls the basic functions of the arrangement 400. Those functions associated may be included as instructions stored in a program storage/memory 404. In one embodiment of the invention, the program modules associated with the storage/memory 404 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 400 via data signals, such as being downloaded electronically via one or more networks, such as the Internet and an intermediate wireless network(s).

The mobile computing arrangement 400 includes hardware and software components coupled to the processing/control unit 402 for performing network data exchanges. The mobile computing arrangement 400 may include multiple network interfaces for maintaining any combination of wired or wireless data connections. In particular, the illustrated mobile computing arrangement 400 includes wireless data transmission circuitry for performing network data exchanges.

This wireless circuitry includes a digital signal processor (DSP) 406 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 408, generally coupled to an antenna 410, transmits the outgoing radio signals 412 and receives the incoming radio signals 414 associated with the wireless device.

The incoming and outgoing radio signals 412, 414 to communicate with a mobile services network 416. The network 416 may include any voice and data communications infrastructure known in the art, including CDMA, W-CDMA, GSM, EDGE, etc. The network 416 may also include short-range networks, using technologies such as 802.11 Wireless Local Area Network (WAN), Ultrawideband (UWB), Bluetooth, etc. The transceiver 408 may be adapted to communicate via these short-range networks 416, or the arrangement 400 may include an alternate data interface 418 for purposes of connecting to such networks. The alternate data interface 418 may include any combination of wired or wireless data communications circuitry coupled to the processor 402 for purposes of communicating with devices on the network 416.

The processor 402 is also coupled to user-interface elements 420 associated with the mobile terminal 400. The user-interface 420 of the mobile terminal 400 may include, for example, a display 422 such as a liquid crystal display. Other user-interface mechanisms may be included in the interface 420, such as keypads 424, speakers, microphones, voice commands, switches, touch pad/screen, graphical user interface using a pointing device, trackball, joystick, etc. These and other user-interface components are coupled to the processor 402 as is known in the art.

The program storage/memory 404 typically includes operating systems for carrying out functions and applications associated with functions on the mobile computing arrangement 400. The program storage 404 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 404 of the mobile computing arrangement 400 may also include software modules for performing functions according to embodiments of the present invention.

In particular, the program storage/memory 404 may include a preferences module 426 for collecting user preferences via user actions and/or behaviors. For example, the preferences collection module 426 may communicate with a behaviors interface 428 that determines user behavior patterns related to access of applications 430 of the device. The applications 430 may include media players, browsers, games, email, instant messaging, or any other application that regularly receives user input that may indicate preferences of the user related to digital content. The applications 430 and behaviors interface 428 may inter-communicate using a standard Application Program Interface (API) provided by any combination of the operating system, applications 430, and/or the behaviors interface 428. In another arrangement, the behaviors interface 428 may be implemented as a plug-in module that is loaded by the applications 430 at run time.

Generally, the behaviors interface 428 and the applications 430 collect preference data without the user's explicit input related to preferences. The preference data collected by the behaviors interface 428 may require some statistical analysis to ensure unusual or outlier data does not get included with the user preferences. In contrast, an interface that directly accepts user preference inputs, as represented by an actions interface 432, will not need to do any statistical derivation of actual preferences, because it may be safely assumed that the user's explicit declaration of preferences is accurate.

The actions user interface 432 determines preferences based on explicit user inputs. The actions user interface 432 may appear as a stand-alone application, or may be integrated with user applications (e.g., applications 430). For example, the actions user interface 432 may be implemented as a plug-in component that is loaded at run-time into another of the applications 430 running on the device 400. The actions interface 432 can provide the user a consistent interface for directly affecting preferences, even when the interface 432 is used with different applications.

Generally, the preference data collected by the collection interface 426 can be stored locally in a local preferences database 434. The local preferences database 434 may use any type of persistent or non-persistent data storage that allows accessing, adding, deleting, and modifying of preference data. The storage of preferences in the database 434 may be for either short-term and/or long-term storage purposes. The data stored in the database 434 can be used locally, such as being access by the applications 430 for selecting local content. Another use of the locally stored preference data 434 is to share it with other network entities via a preferences network interface 436.

The preferences network interface 436 may utilize data structures and protocols for exchanging preference data with service and client elements of the network 416. For example, the preferences network interface 436 may communicate with a community preference server 440 for purposes of adding/merging local preference data 434 to the preferences of the community. Similarly, the preferences network interface 436 may communicate the preference data 434 to a generic preference server 442 which maintains user-specific versions of preference data. The preference servers 440, 442 may collect, analyze, correlate, and store data for purposes of providing content to the user device 400. This content may be stored on the device 400 itself (as represented by content database 446), and/or provided real-time (e.g., streamed) by a network-coupled content server 444.

The device may include one or more content renderers 448 for rendering the network content 444 and/or locally stored content 446. The content renderer 448 may be included as a generic application 430, or may be a custom application designed to interface with the network content server 444, preference servers 440, 442, and local preference collection module 426. For example, the content renderer 448 may include facilities for managing and rendering content based on different communities maintained by the community preference server 440, selecting and managing categories and sub-categories of preferences, synchronizing preferences between different mediums (e.g., music, television), and other preference-specific features that may not be included in generic rendering software.

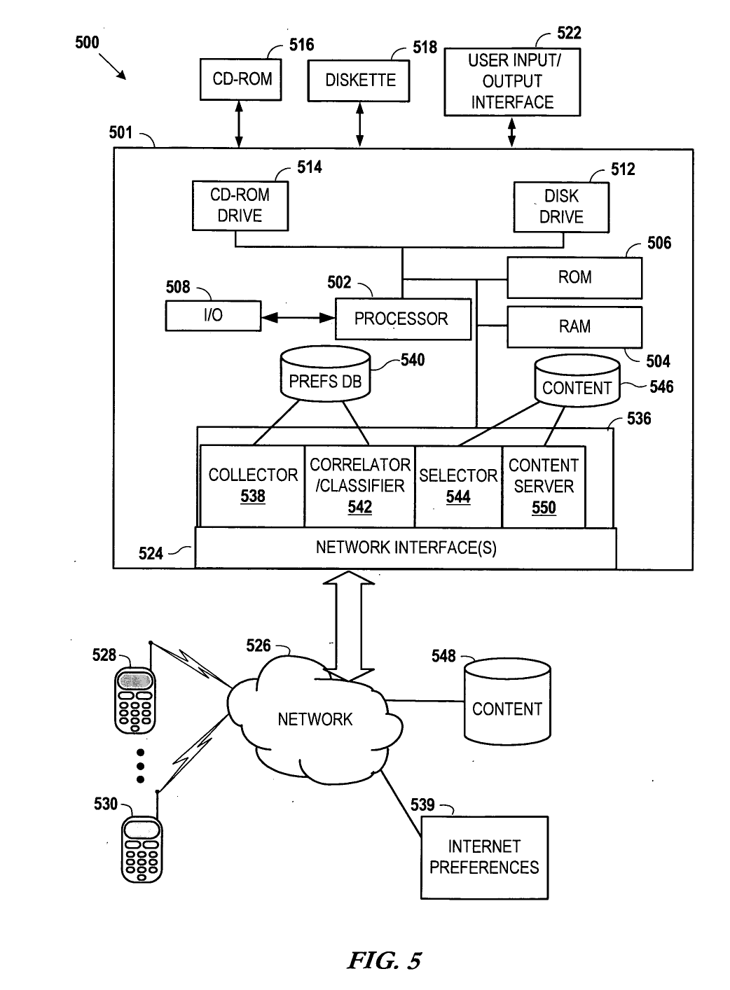

In the preceding figures, various examples were presented of network environments where user devices share preferences for selection and rendering of media according to embodiments of the invention. In some arrangements, one or more fixed servers may assist in gathering preferences, selecting media based on the preferences, and rendering the selected media. Many types of apparatus may be able to act as such a server, including conventional desktop a portable computers, set top boxes, digital media centers, portable communications devices, and other processing devices known in the art. In reference now to FIG. 5, a block diagram illustrates an example server 500 according to embodiments of the invention. The server 500 includes a computing arrangement 501. The computing arrangement 501 may include custom or general-purpose electronic components. The computing arrangement 501 includes a central processor (CPU) 502 that may be coupled to random access memory (RAM) 504 and/or read-only memory (ROM) 506. The ROM 506 may include various types of storage media, such as programmable ROM (PROM), erasable PROM (EPROM), etc. The processor 502 may communicate with other internal and external components through input/output (I/O) circuitry 508. The processor 502 carries out a variety of functions as is known in the art, as dictated by software and/or firmware instructions.

The computing arrangement 501 may include one or more data storage devices, including hard and floppy disk drives 512, CD-ROM drives 514, and other hardware capable of reading and/or storing information such as DVD, etc. In one embodiment, software for carrying out the operations in accordance with the present invention may be stored and distributed on a CD-ROM 516, diskette 518 or other form of media capable of portably storing information. These storage media may be inserted into, and read by, devices such as the CD-ROM drive 514, the disk drive 512, etc. The software may also be transmitted to computing arrangement 501 via data signals, such as being downloaded electronically via a network, such as the Internet. The computing arrangement 501 may be coupled to a user input/output interface 522 for user interaction. The user input/output interface 522 may include apparatus such as a mouse, keyboard, microphone, touch pad, touch screen, voice-recognition system, monitor, LED display, LCD display, etc.

The computing arrangement 501 may be coupled to other computing devices via networks. In particular, the computing arrangement includes a network interface 524 capable of interacting with a network 526. The network interface 524 may include a combination of hardware and software components, including media access circuitry, drivers, programs, and protocol modules. Ultimately, the computing arrangement 501 may be enabled via the network interface 524 to exchange media preference data between devices 528, 530 of the network 526, and to exchange media and associated metadata with devices such as media renderer 532 and media server 534.

The computing arrangement 501 includes processor executable instructions 536 for carrying out tasks of the computing arrangement 501. These instructions 540 may include a collector 538 that collects preference data from user devices 528, 530 via the network 526 (or other data communication medium). The collector 538 may also collect preferences data from entities that are not included in the local group of devices 528, 530, such as Internet preferences 539.

The collected preference data may be placed in a database 540. A correlator/classifier 542 generally reduces and classifies the collected preference data 540 into formats suitable for a selector component 544 to assist the user devices 528, 530 in finding data via the network 526 or elsewhere. In one embodiment, the correlator/classifier 542 merges the collected preference data into a single set of data associated with one or more groups. The stored group data 540 can be used to assist members of the group in selecting network content. In another embodiment, the correlator/classifier 542 stores preference data for each individual user of the devices 528, 530, and uses the stored data 540 to assist the users of the devices 528, 530 on an individual basis.

The selector component 544 assists the user devices 528, 530 in choosing content in accordance with the tastes of the users. This assistance may be in the form of modifying search queries originating from the devices 528, 530, modifying results of search queries that are sent to the devices 528, 530, pushing content to the devices 528, 530, and storing the content for the benefit of the devices 528, 530, such as on a locally accessible content database 546. The content that is ultimately used by the user devices 528, 530 may originate from the local content storage 546 via a content server interface 550. The content may also originate from other data processing elements, such as a content server 548 coupled to the network 526.

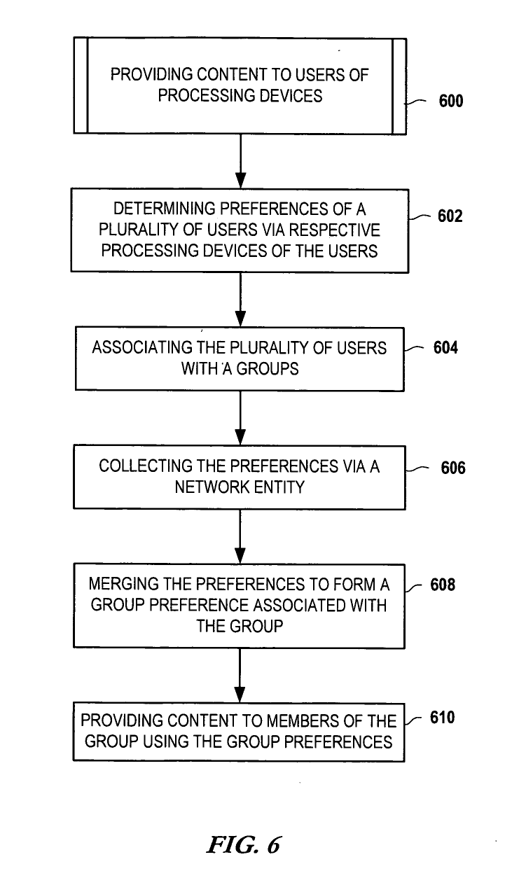

In reference now to FIG. 6, a flowchart illustrates a procedure 600 for providing content to users of processing devices according to embodiments of the invention. The preferences of a plurality of users are determined 602 via respective processing devices of the users. The plurality of users are associated 604 with a group, and the preferences are collected 606 to a common data storage device. The preferences are merged 608 to form a group preference associated with the group, and content is proved 610 to members of the group using the group preferences.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method, comprising:
determining preferences of a plurality of users via respective processing devices of the users, wherein the processing devices are capable of being coupled to a network;
collecting the preferences via a network entity;
merging the preferences to form a group preference associated with the plurality of users; and
providing content to at least one of the users using the group preferences.

2. The method of claim 1, wherein providing the content to the at least one user using the group preferences comprises tailoring of a content search initiated by the at least one user in conformance with the group preferences.

3. The method of claim 2, wherein tailoring of the content search in conformance with the group preferences comprises modifying a search query sent out by the at least one user.

4. The method of claim 2, wherein tailoring of the content search in conformance with the group preferences comprises modifying a response to a search query sent out by the at least one user.

5. The method of claim 1, wherein providing the content to the at least one user using the group preferences pushing the content to the processing device of the at least one user via the network.

6. The method of claim 1, wherein determining the preferences of the plurality of users via the respective processing devices of the users comprises deriving preferences based on interactions between the plurality of users and applications of the respective processing devices.

7. The method of claim 1, wherein determining the preferences of the plurality of users via the respective processing devices of the users comprises accepting explicit indicators of the preferences from the users via user interfaces of the data processing devices.

8. The method of claim 1, further comprising:
combining an individual preference of the at least one user with the group preference to form a resultant preference that reflects the individual preference and the group preference; and
providing content to the at least one user using the resultant preference.

9. The method of claim 8, wherein combining the individual preference of the at least one user with the group preference to form the resultant preference comprises applying predetermined respective weightings to the individual preferences and the group preferences.

10. The method of claim 1, wherein merging the preferences to form the group preference further comprises merging the preferences with a separate source of preferences that is independent of the preferences of the plurality of users.

11. The method of claim 10, wherein the separate source of preference comprises an Internet content provider service.

12. The method of claim 1, wherein the preferences of the plurality of users are formatted using two or more incompatible formats, and wherein merging the preferences to form the group preference further comprises translating the preferences to a common format.

13. An apparatus, comprising:
a network interface capable of communicating via a network;
a user interface capable of receiving user inputs;
a processor coupled to the network interface and the user interface; and
a memory coupled to the processor, the memory including instructions that cause the processor to,
determine, via the user inputs, preferences of the user of the apparatus that may be used to discover content for rendering via the apparatus;
communicate the user preferences to an entity of the network for purposes of combining the user preferences with preferences of others on the network to form group preferences;
discover, via the entity, content in accordance with the group preferences; and
retrieve the content via the network for purposes of rendering the content to the user.

14. The apparatus of claim 13, wherein the memory further comprises one or more applications that accept inputs via the user interface, and wherein the instructions cause the processor to determine the preferences of the user based on interactions between the user and the one or more applications.

15. The apparatus of claim 13, wherein the user inputs comprise explicit indicators of the preferences input from by the user via the user interface.

16. A computer-readable medium having instructions stored thereon which are executable by a processing device capable of being coupled to a network for performing steps comprising:
determining, via a user interface of the processing device, preferences of the user of the processing device that may be used to discover content for rendering via the processing device;
communicating the user preferences to an entity of the network for purposes of combining the user preferences with preferences of others on the network to form group preferences;
discovering, via the entity, content in accordance with the group preferences; and
retrieving the content via the network for purposes of rendering the content to the user.

17. An apparatus, comprising:
a network interface capable of communicating with a plurality of user devices via a network;
a processor coupled to the network interface; and
a memory coupled to the processor, the memory including instructions that cause the processor to,
collect, via the plurality of user devices, preferences of the respective users of the plurality of user devices, wherein the preferences are determined via the plurality of user devices;
merge the preferences to form a group preference associated with the users of the plurality of user devices; and
facilitate providing content to users using the group preferences.

18. The apparatus of claim 17, wherein the instructions cause the processor to facilitate providing the content to the users using the group preferences by tailoring of a content search initiated by at least one of the users in conformance with the group preferences.

19. The apparatus of claim 18, wherein the instructions cause the processor to tailor the content search in conformance with the group preferences by modifying a search query sent out by the at least one user.

20. The apparatus of claim 18, wherein the instructions cause the processor to tailor the content search in conformance with the group preferences by modifying a response to a search query sent out by the at least one user.

21. The apparatus of claim 17, wherein the instructions further cause the processor to:
combine an individual preference of at least one of the users with the group preference to form a resultant preference that reflects the individual preference and the group preference; and
provide content to the at least one user using the resultant preference.

22. The apparatus of claim 17, wherein the instructions cause the processor to merge the preferences to form the group preference further by merging the preferences with a separate source of preferences that is independent of the preferences of the plurality of users.

23. The apparatus of claim 22, wherein the separate source of preference comprises an Internet content provider service.

24. The apparatus of claim 17, wherein the preferences of the plurality of users are formatted using two or more incompatible formats, and wherein the instructions cause the processor to merge the preferences to form the group preference by translating the preferences to a common format.

25. A computer-readable medium having instructions stored thereon which are executable by a server device capable of being coupled to a network for performing steps comprising:
collecting, via a plurality of user devices coupled to the network, preferences of the respective users of the plurality of user devices, wherein the preferences are determined via the plurality of user devices;
merging the preferences to form a group preference associated with the users of the plurality of user devices; and
facilitating providing content to users using the group preferences.
